(19) United States
(12) Patent Application Publication
(10) Pub. No.: US 2016/0180330 A1
(43) Pub. Date: Jun. 23, 2016

(54) METHOD AND SYSTEM FOR RECOVERY OF A LOST PAYMENT CARD

(71) Applicant: MasterCard International Incorporated, Purchase, NY (US)

(72) Inventor: Jason A. FELDMAN, New York, NY (US)

(73) Assignee: MasterCard International Incorporated, Purchase, NY (US)

(21) Appl. No.: 14/580,601

(22) Filed: Dec. 23, 2014

(51) Int. Cl. G06Q 20/34; G06Q 20/40

(52) U.S. Cl. CPC G06Q 20/354; G06Q 20/40

(57) ABSTRACT

A method for reactivation of a lost payment card includes: storing an account profile including data related to a transaction account including an account identifier, account number, authentication data, and activation flag, the flag indicating that a payment card is active; receiving an authorization request for a payment transaction, the request including the account number and a data field indicative of a lost payment card; updating the activation flag in the account profile to indicate that the payment card is frozen; receiving a verification message, the message including the account identifier and authentication information; authenticating the received verification message based on the included authentication information and the authentication data included in the account profile; and updating the activation flag in the account profile i to indicate that the payment card is active, wherein the payment card is prohibited from use if the activation flag indicates that the card is frozen.

### FIELD

The present disclosure relates to the recovery of a lost payment card, specifically the deactivation and reactivation of a lost payment card where recovery is facilitated by a merchant in possession of the lost payment card.

### BACKGROUND

Despite the best efforts of consumers and merchants, consumers occasionally lose their payment card. A lost payment card can be detrimental not only to the consumer, but also to merchants, issuers, and payment networks. When a payment card is lost, the consumer often has to notify their issuer, who will then print and send a new payment card to the consumer. The consumer must receive and then activate the card prior to initiating any transactions with the new card. This process can often take a number of days, during which time the consumer is inconvenienced and no charges can be made on the related transaction account, resulting in a loss of revenue for issuers, acquirers, and payment networks. Therefore, it can be in the best interests of each entity involved in payment transactions to ensure that consumers can quickly and easily recover a lost payment card.

In some instances, a lost payment card may be initially recovered by a merchant, such as when the card is not recovered by a consumer after paying a bill at a restaurant, but be lost to the consumer. The merchant may not have any contact information for the consumer, and may therefore be unable to reach out to the consumer and let them know that their card is safe. As a result, the consumer may report their card lost and await a new one, when they would have otherwise been able to quickly recover their card.

Thus, there is a need for a technical system whereby a merchant can report possession of a lost payment card in such a way that the consumer can be notified and provided with an opportunity to recover their card, while maintaining privacy and security of the consumer's contact information and enabling proper verification of the consumer as an authorized person upon recovery of the card.

### SUMMARY

The present disclosure provides a description of systems and methods for recovery of a lost payment card.

A method for deactivation and reactivation of a lost and recovered payment card includes: storing, in an account database, an account profile, wherein the account profile includes data related to a transaction account including at least an account identifier, an account number, authentication data, and an activation flag, the activation flag indicating that a payment card associated with the related transaction account is active; receiving, by a receiving device, an authorization request for a payment transaction, wherein the authorization request includes at least the account number and at least one data field including a value indicative of a lost payment card; updating, by a processing device, the activation flag in the account profile in the account database to indicate that the payment card associated with the related transaction account is frozen; receiving, by the receiving device, a verification message, wherein the verification message includes at least the account identifier and authentication information; authenticating, by the processing device, the received verification message based on at least the included authentication information and the authentication data included in the account profile; and updating, by the processing device, the activation flag in the account profile in the account database to indicate that the payment card associated with the related transaction account is active, wherein the payment card associated with the related transaction account is prohibited from use in payment transactions if the activation flag indicates that the payment card is frozen.

A system for deactivation and reactivation of a lost and recovered payment card includes an account database, a receiving device, and a processing device. The account database is configured to store an account profile, wherein the account profile includes data related to a transaction account including at least an account identifier, an account number, authentication data, and an activation flag, the activation flag indicating that a payment card associated with the related transaction account is active. The receiving device is configured to receive an authorization request for a payment transaction, wherein the authorization request includes at least the account number and at least one data field including a value indicative of a lost payment card. The processing device is configured to update the activation flag in the account profile in the account database to indicate that the payment card associated with the related transaction account is frozen. The receiving device is further configured to receive a verification message, wherein the verification message includes at least the account identifier and authentication information. The processing device is further configured to: authenticate the received verification message based on at least the included authentication information and the authentication data included in the account profile; and update the activation flag in the account profile in the account database to indicate that the payment card associated with the related transaction account is active. The payment card associated with the related transaction account is prohibited from use in payment transactions if the activation flag indicates that the payment card is frozen.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for recovery of a lost payment card in accordance with exemplary embodiments.

FIG. 2 is a block diagram illustrating the processing server of FIG. 1 for the deactivation and reactivation of a lost and recovered payment card in accordance with exemplary embodiments.

FIGS. 3 and 4 are flow diagrams illustrating processes for notification and recovery of a lost payment card using the system of FIG. 1 in accordance with exemplary embodiments.

FIG. 5 is a flow diagram illustrating a process for reactivation and deactivation of a payment card using the processing server of FIG. 2 in accordance with exemplary embodiments.

FIG. 6 is a flow chart illustrating an exemplary method for deactivation and reactivation of a lost and recovered payment card in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

### System for Recovery of a Lost Payment Card

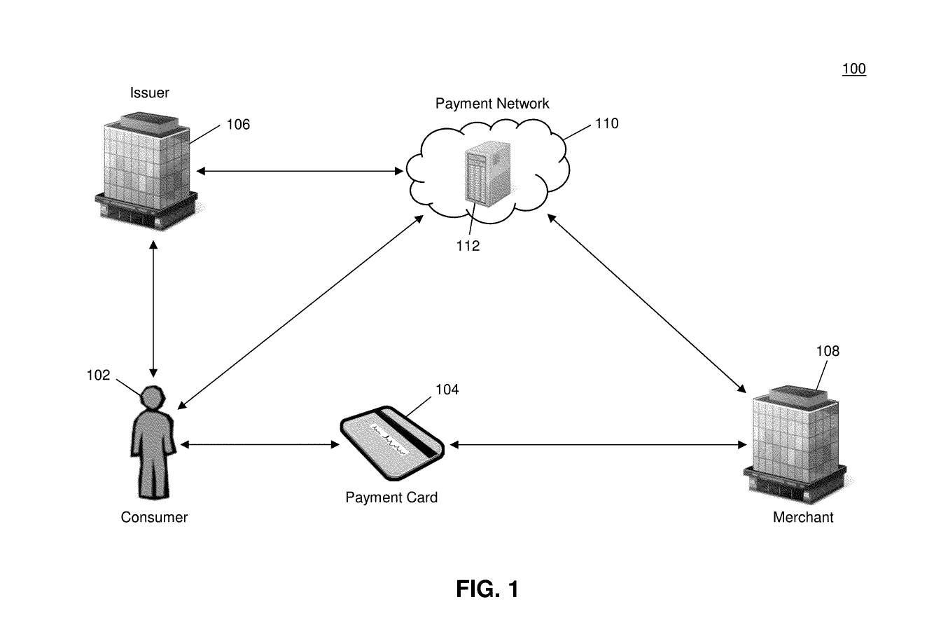

FIG. 1 illustrates a system 100 for the recovery of a lost payment card and the deactivation and subsequent reactivation thereof.

In the system 100, a consumer 102 may have a payment card 104 that is issued by an issuer 106, which may be an issuing financial institution, such as an issuing bank. The consumer 102 may visit a merchant 108, and, during the course of the visit, may lose the payment card 104 at the merchant 108. In some instances, the payment card 104 may be lost subsequent to its use in a payment transaction. In other instances, the payment card 104 may not be used at all prior to its loss or misplacement at the merchant 108.

The merchant 108 may initiate a special form of payment transaction using a point of sale device or other suitable computing device using the payment card 104. The special transaction may result in the submission of an authorization request (e.g., directly from the merchant 108 or via an acquiring financial institution) to a payment network 110 for processing. The payment network 110 may identify the special nature of the transaction as the reporting of the payment card 104 as lost. The transaction may be identified via a data field included in the authorization request that indicates that the transaction is the reporting of a lost payment card. In some instances, the transaction may be for a zero transaction amount, which may indicate that the transaction is reporting the card as lost.

The payment network 110 may include a processing server 112. The processing server 112, discussed in more detail below, may be configured to generate a notification to notify the consumer 102 that the payment card 104 has been recovered by the merchant 108 and is available for recovery by the consumer 102. In some instances, a verification code may be generated by the processing server 112 and provided to both the merchant 108 and the consumer 102 (e.g., via the notification). In such an instance, the consumer 102 can provide the verification code to the merchant 108 to authenticate the consumer 102 as a person authorized to recover the payment card 104.

In some embodiments, the processing server 112 may transmit the notification to the issuer 106, who may then forward the notification to the consumer 102 using previously acquired contact information. For instance, the consumer 102 may have provided contact information to the issuer 106 as part of the process for obtaining the transaction account related to the payment card 104. In other embodiments, the processing server 112 may transmit the notification directly to the consumer 102. In such an embodiment, the processing server 112 may receive contact information for the consumer 102 from the issuer 106, the consumer 102, or a third party. In some instances, the consumer 102 may provide consent to be contacted by the payment network 110 prior to the obtaining of contact information by the processing server 112.

In some embodiments, the processing server 112 may request contact information from the issuer 106, who may in turn provide contact information to the processing server 112 without necessarily providing any other personally identifiable information. For example, the processing server 112 may provide the account number associated with the payment card 104 (e.g., and included in the received authorization request) to the issuer 106. The issuer 106 may identify the associated transaction account and may provide one or more of an e-mail address, device identifier, telephone number, or other suitable contact information to the processing server 112 without providing any additional information that may be considered personally identifiable. The contact information may be a unique identifier (e.g., one time use e-mail address) linked by a third party to the customer's actual contact information (e.g., e-mail or other contact information) so as not to release personally identifiable information to the merchant.

The notification may be transmitted to the consumer 102 using methods and systems that will be apparent to persons having skill in the relevant art. For instance, the processing server 112 or issuer 106 may transmit a message to a computing device associated with the consumer 102, such as via a short message service, multimedia message service, e-mail service, application program, etc.

Once the consumer 102 has received the notification, they may visit the merchant 108 and request their payment card 104. In instances where a verification code was provided to the consumer 102 and merchant 108, the consumer 102 may present the verification code to the merchant 108 for authentication. In other instances, the merchant 108 may require other information from the consumer 102 to verify that the consumer 102 is authorized to retrieve the payment card 104, such as a picture ID (e.g., a driver's license, etc.). The merchant 108 may then return the payment card 104 to the consumer 102.

In some embodiments, the processing server 112 may be configured to freeze or otherwise deactivate the transaction account related to the payment card 104 when the payment card 104 is reported as lost via the transaction initiated by the merchant 108. In such an instance, the processing server 112 may flag the transaction account such that any transactions that are received that include the payment card 104 as payment are declined until recovery of the payment card 104 has been confirmed.

In such an embodiment, the consumer 102 may report recovery of the payment card 104 once the card has been recovered from the merchant 108. In one instance, the consumer 102 may contact the payment network 110 directly using a pre-established method of communication and report that the payment card 104 has been recovered. In another instance, the consumer 102 may notify the issuer 106, who may in turn notify the payment network 110, such as by logging in to an online banking account where the login credentials may be used as authentication of the consumer 102. In yet another instance, the consumer 102 may use the payment card 104 in a transaction and enter a personal identification number or other credentials that may be used to authenticate the consumer 102, such that the processing server 112 may ensure that an authorized person (e.g., the consumer 102) has recovered the payment card 104.

In another example, the payment network 110 may provide a second verification code to the consumer 102, which may be returned by the consumer 102 to the payment network 110 once the payment card 104 has been recovered, to confirm its safe receipt. In yet another example, the consumer 102 may use the payment card 104 at an automated teller machine (ATM) to confirm safe receipt of the payment card, using one or more traditional functions of the ATM. In a further example, the consumer 102 may login to an account with the issuer 106 using a website, mobile application program, or other suitable method, to confirm safe receipt of the payment card 104.

Once the recovery of the payment card 104 by the consumer 102 has been confirmed, the processing server 112 may reactivate the transaction account such that future payment transactions using the payment card 104 will be processed as normal. In some embodiments, the deactivation and reactivation may be performed by the issuer 106, such as following notifications provided by the processing server 112 regarding recovery of the payment card 104.

In some embodiments, the consumer 102 may authorize a second person to retrieve the payment card 104 on their behalf. In such an embodiment, the consumer 102 may notify the payment network 110 of the authorized agent, and the payment network 110 may provide the verification code to the agent. In another instance, the consumer 102 may provide the verification code to the agent, who may provide it to the merchant 108 when retrieving the payment card 104. Recovery of the payment card 104 by the authorized agent may be confirmed by the payment network 110 via the consumer 102 or other methods, such as the use of a second verification code by the agent, initiation of a transaction by the agent at the merchant 108, or use of the payment card 104 at an ATM using a temporary identification number.

The methods and systems discussed herein may enable the processing server 112 to facilitate the fast and efficient recovery of a lost payment card 104. The reporting of the payment card 104 as lost via an authorization request can ensure that merchants 108 are able to report lost payment cards 104 using existing systems without requiring to modify their point of sale hardware systems or to significantly re-train personnel regarding new communications to be made. A simple software modification to support a “lost” flag would suffice, and even that is not required if the flag can be an odd use of a conventional communication, such as a specific small transaction amount (e.g., 2 cents) that could be used to identify a lost card if not likely to occur in normal or other transactions. As a result, lost payment cards can be reported quickly and easily using the processing server 112. Additionally, the methods and systems discussed herein also enable the processing server 112 to facilitate the secure recovery of the payment card via the verification code and authentication of the consumer 102 using secure methods, such as via a payment transaction or secure communication with the issuer 106 using already established channels. Therefore, the processing server 112 can provide for the quick and efficient recovery of payment cards using the existing payment network 110 via the specially indicative authorization request.

### Processing Server

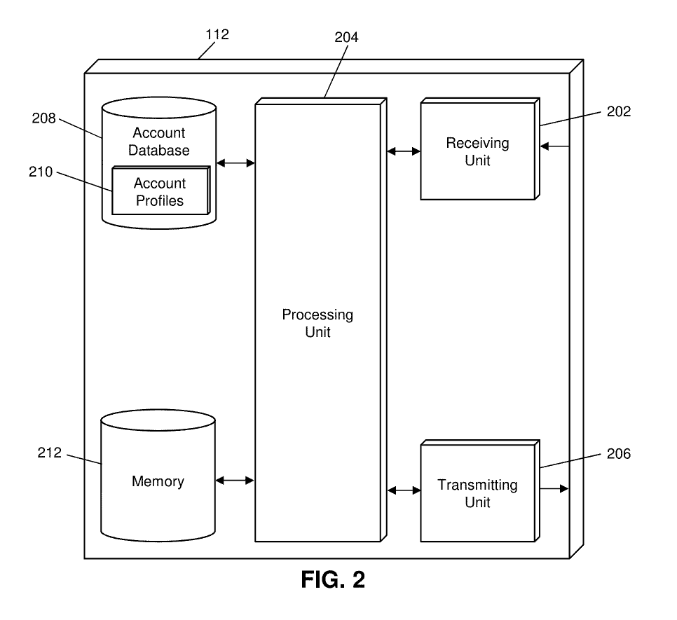

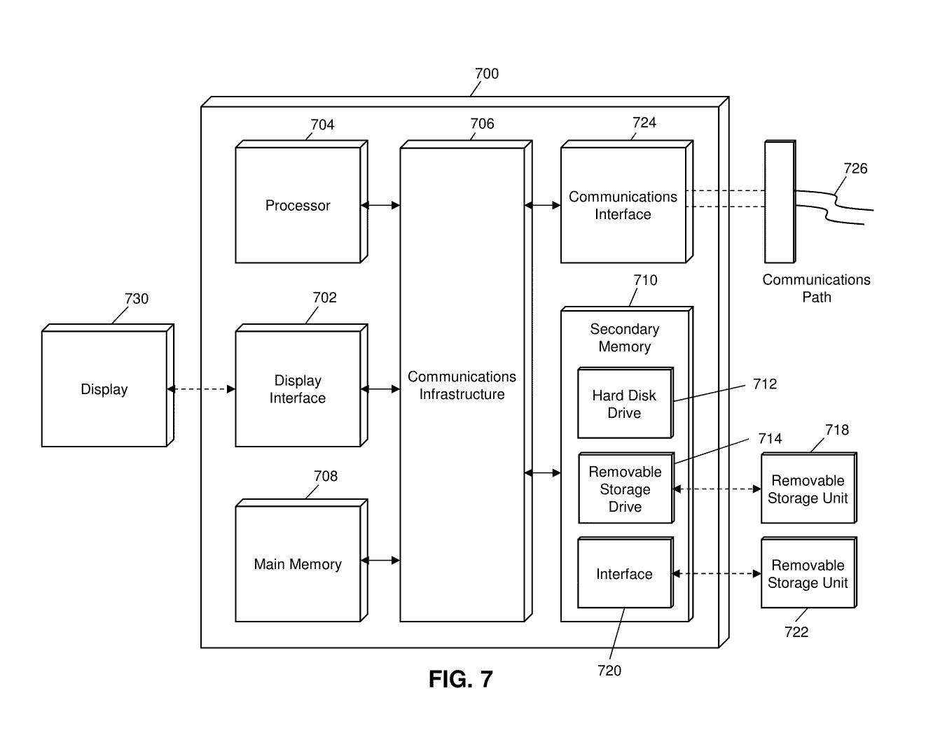

FIG. 2 illustrates an embodiment of the processing server 112 of the system 100. It will be apparent to persons having skill in the relevant art that the embodiment of the processing server 112 illustrated in FIG. 2 is provided as illustration only and may not be exhaustive to all possible configurations of the processing server 112 suitable for performing the functions as discussed herein. For example, the computer system 700 illustrated in FIG. 7 and discussed in more detail below may be a suitable configuration of the processing server 112.

The processing server 112 may include an account database 208. The account database 208 may be configured to store a plurality of account profiles 210. Each account profile 210 may include data related to a transaction account including an account number, authentication data, and an activation flag. The account number may be a unique value associated with the related transaction account suitable for identification, such as a transaction account number, e-mail address, telephone number, registration number, etc. The authentication data may be data suitable for use in authenticating a consumer 102 or other authorized person associated with the related transaction account, such as a personal identification number, password, biometric data (e.g., fingerprint, retinal scan, etc.), or other suitable type of authentication data that will be apparent to persons having skill in the relevant art.

The activation flag may be a flag that indicates if a payment card 104 associated with the account profile 210 and the related transaction account is active. When the flag indicates that the payment card 104 is active, payment transactions involving the payment card 104 may be processed using normal payment transaction processing procedures. When the flag indicates that the payment card is not active (e.g., is frozen), payment transactions involving the payment card 104 may be denied.

The processing server 112 may include a receiving unit 202. The receiving unit 202 may be configured to receive data over one or more networks via one or more network protocols. The receiving unit 202 may receive an authorization request for a payment transaction that includes an account identifier associated with a lost payment card 104 and also includes a data field indicating that the payment transaction is for the lost payment card 104. The data field may be the transaction amount field, which may include a zero transaction amount as the indication. In some embodiments, the data field may be a reserved data field that is used for the recovery of lost payment cards. The authorization request may also include a merchant identifier associated with the merchant 108 involved in the payment transaction.

The processing server 112 may also include a processing unit 204. The processing unit 204 may be configured to perform the functions of the processing server 112 discussed herein as will be apparent to persons having skill in the relevant art. The processing server 112 may identify an account profile 210 in the account database 208 that corresponds to the received authorization request based on the included account identifier. The processing server 112 may be configured to generate a notification. The notification may include at least the merchant identifier included in the authorization request, and/or additional merchant information associated with the merchant 108, such as a name, geographic location, street address, etc.

The processing server 112 may also include a transmitting unit 206 configured to transmit data over one or more networks via one or more network protocols. The transmitting unit 206 may transmit the generated notification using methods and systems that will be apparent to persons having skill in the relevant art. The transmitting unit 206 may transmit the notification to the issuer 106, for forwarding to the consumer 102. In some embodiments, the identified account profile 210 may include contact information associated with the consumer 102. In such an embodiment, the transmitting unit 206 may transmit the notification to the consumer 102 using the included contact information.

In some instances, the transmitting unit 206 may transmit the account identifier to the issuer 106 or a third party in a request for contact information. In such an instance, the receiving unit 202 may be configured to receive contact information in response to the request, which may then be used by the transmitting unit 206 in the transmitting of the generated notification to the consumer 102 using the received contact information.

In some embodiments, the processing unit 204 may be configured to toggle the activation flag included in the identified account profile 210 to indicate that the payment card 104 has been deactivated due to its status as being lost. In such an embodiment, the payment network 110 may be configured to decline payment transactions involving the payment card 104. In instances where the processing server 112 is configured to process payment transactions, the processing unit 204 may decline the payment transactions based on the activation flag. In other instances, the transmitting unit 206 may transmit a notification to a computing device of the payment network 110 that is configured to process the transactions indicating that transactions involving the payment card 104 should be denied.

In some embodiments, the processing unit 204 may be further configured to generate a verification code. The verification code may be a random number or pseudo-random number, or other suitable value, that may be included in the generated notification that is provided to the consumer 102. The transmitting unit 206 may be configured to also transmit the verification code to the merchant 108, for use by the merchant in authenticating the consumer 102 as an authorized recovering person for the payment card 104.

The receiving unit 202 may also be configured to receive a verification message that indicates that the payment card 104 has been recovered. The verification message may include at least the account identifier for the identified account profile 210 and authentication data. The authentication data may be compared to the authentication data included in the account profile 210 by the processing unit 204 to authenticate that the payment card 104 has been recovered by an authorized party. In some embodiments, the authentication data may be a notification from the issuer 106 or other authenticating agency indicating that authentication of the consumer 102 was successful (e.g., via the login of the consumer 102 to an account with the issuer 106). In other embodiments, the authentication data may be a personal identification number or other form of authentication (e.g., biometric data, password, etc.) provided by the consumer 102, such as via an application program or part of a payment transaction (e.g., in which the verification message is an authorization request).

Once the authentication has been performed and is successful, the processing unit 204 may update the activation flag in the account profile 210 to reactivate the payment card 104. The consumer 102 may then return to regular use of the payment card 104.

In some embodiments, if one or more payment transactions are attempted using the payment card 104 prior to recovery of the payment card 104 being authenticated, the processing server 112 and/or payment network 110 may notify the issuer 106. In such an instance, the issuer 106 may determine that the payment card 104 has been stolen or recovered by an unauthorized party and cancel the payment card 104. In some instances, the issuer 106 may contact the consumer 102 directly regarding use of the payment card 104 to determine if the payment transactions were initiated by an authorized party that had recovered the payment card 104.

In some embodiments, each account profile 210 may include both an account identifier and an account number. In such an embodiment, the account identifier may be an identification value other than the account number, and may be used in place of the account number, such as to preserve account security. For example, a verification message received by the receiving unit 202 from the consumer 102 or issuer 106 may include the account identifier and not account number, which may be used for identification of the account profile 210 without the potential for compromise to the account number.

The processing server 112 may also include a memory 212. The memory 212 may be configured to store data suitable for performing the functions disclosed herein. For example, the memory 212 may be configured to store rules regarding the identification of an authorization request as being indicative of a lost payment card, rules for authentication of an account profile, rules for the collection and/or use of consumer contact information, etc. Additional data included in the memory 212 will be apparent to persons having skill in the relevant art.

### Process for Recovery of a Lost Payment Card

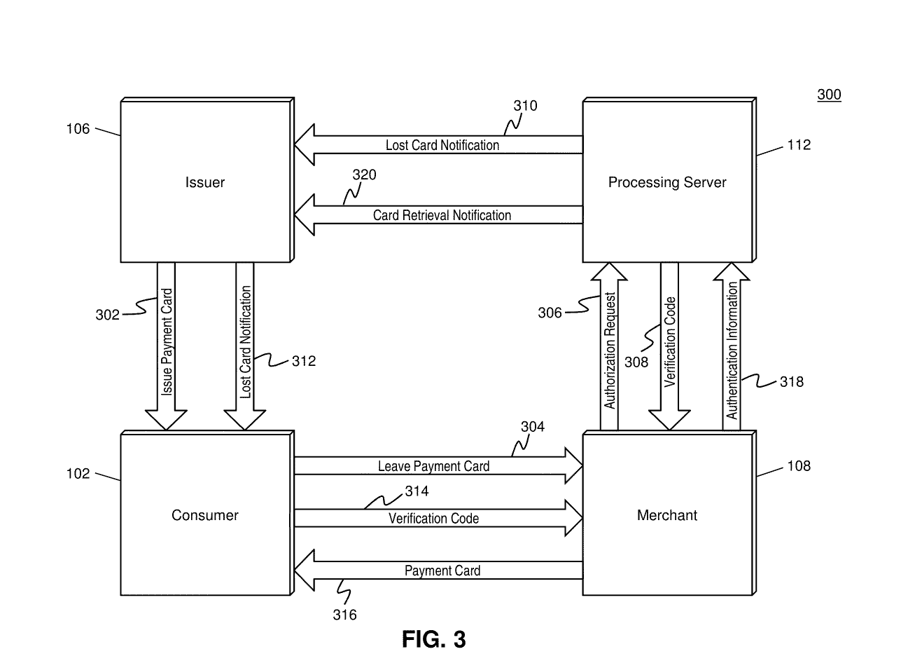

FIG. 3 illustrates a process 300 for the recovery of a lost payment card using the system 100.

In step 302, the issuer 106 may issue the payment card 104 to the consumer 102. As part of the issuing of the payment card 104, the issuer 106 may provide account information to the processing server 112 for storage in an account profile 210 in the account database 208. In some embodiments, the account profile 210 may be generated and stored upon the first use of the payment card 104.

In step 304, the consumer 102 may leave (e.g., lose or misplace) the payment card 104 at the merchant 108. In step 306, the merchant 108 may use the payment card 104 in a special payment transaction, for which an authorization request may be generated and submitted to the processing server 112. The authorization request may include at least an account identifier associated with the payment card 104 and a data field indicating that the transaction corresponds to a lost payment card. In step 308, the processing server 112 may generate a verification code, which may be transmitted back to the merchant 108 for the lost payment card 104.

In step 310, the processing server 112 may generate a lost card notification that includes information associated with the merchant 108 and the verification code, and transmit the lost card notification to the issuer 106. The issuer 106 may, in step 312, forward the notification on to the consumer 102. In step 314, the consumer 102 may return to the merchant 108 and request the payment card 104, providing the verification code to identify the consumer 102 as an authorized party. In step 316, the merchant 108 may return to the payment card 104 to the consumer 102.

In step 318, the consumer 102 may use the payment card 104 in an additional payment transaction that indicates recovery of the lost payment card 104. The use of the payment card 104 may include the generation and submission of an authorization request to the processing server 112 that include the account identifier and additional authentication information. The processing server 112 may authenticate the consumer 102 using the authentication information, and may, in step 320, transmit a notification to the issuer 106 indicating that the payment card has been successfully recovered.

### Alternative Process for Recovery of a Lost Payment Card

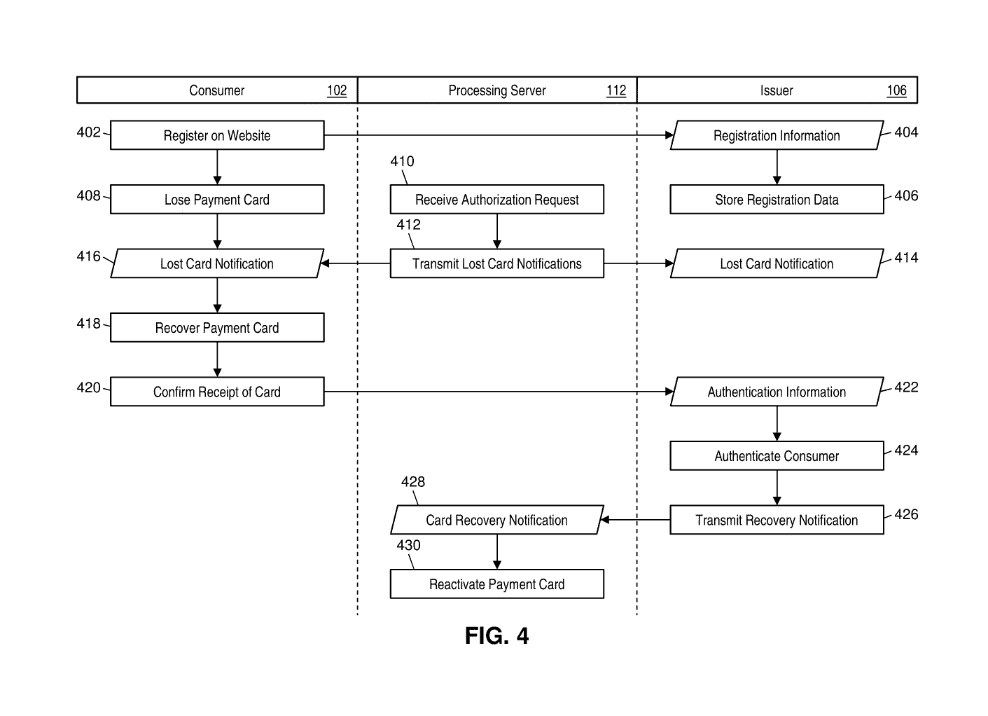

FIG. 4 illustrates an alternative process for the recovery of a lost payment card using the processing server 112 and issuer 106 of the system 100 where the consumer 102 is authenticated via the issuer 106.

In step 402, the consumer 102 may register for management of their transaction account and associated payment card 104 on a website associated with the issuer 106. In step 404, the issuer 106 may receive the registration information, which may include a username, password, and/or other suitable authentication data. In step 406, the issuer 106 may store the authentication data using methods and systems suitable for the storage of authenticated data that will be apparent to persons having skill in the relevant art.

In step 408, the consumer 102 may lose the payment card 104 at the merchant 108. In step 410, the receiving unit 202 of the processing server 112 may receive an authorization request that involves the payment card 104 and indicates that the payment card 104 is a lost payment card. In step 412, the processing unit 204 of the processing server 112 may generate lost card notifications for the consumer 102 and issuer 106, which may be transmitted to the respective parties by the transmitting unit 206 of the processing server 112. In step 414, the issuer 106 may receive the notification, which may indicate that the payment card 104 is lost. The issuer 106 may freeze the transaction account associated with the payment card 104 such that any payment transactions involving the payment card 104 will be denied until recovery of the payment card 104 is confirmed.

In step 416, the consumer 102 may receive the lost card notification. The notification may include a verification code to provide to the merchant 108, and may also include information identifying the merchant 108, such as a geographic location and/or merchant name. The consumer 102 may then visit the merchant 108 and, in step 418, recover the payment card 104. In instances where the verification code is used, the consumer 102 may provide the verification code to the merchant 108 in order to recover the payment card 104.

In step 420, the consumer 102 may confirm receipt of the payment card 104 to the issuer 106. The confirmation may be made using the account previously registered by the consumer 102 with the issuer 106, which may include submitting a confirmation upon entry of the proper login credentials to the issuer 106. In step 422, the issuer 106 may receive authentication information from the consumer 102, which may include the login credentials provided when confirming receipt of the payment card 104. In step 424, the issuer 106 may authenticate the consumer 102 to authenticate that an authorized party has recovered the payment card 104, via authentication of the received information.

Once the consumer 102 has been authenticated and recovery of the payment card 104 verified, then, in step 426, the issuer 106 may transmit a recovery notification to the processing server 112. In step 428, the receiving unit 202 of the processing server 112 may receive the card recovery notification, which may include at least the account identifier and an indication that the payment card 104 is received. In step 430, the processing unit 204 of the processing server 112 may update the activation flag in the account profile 210 to indicate that the payment card 104 has been recovered and is activated for use.

### Process for Deactivation and Reactivation of a Lost Payment Card

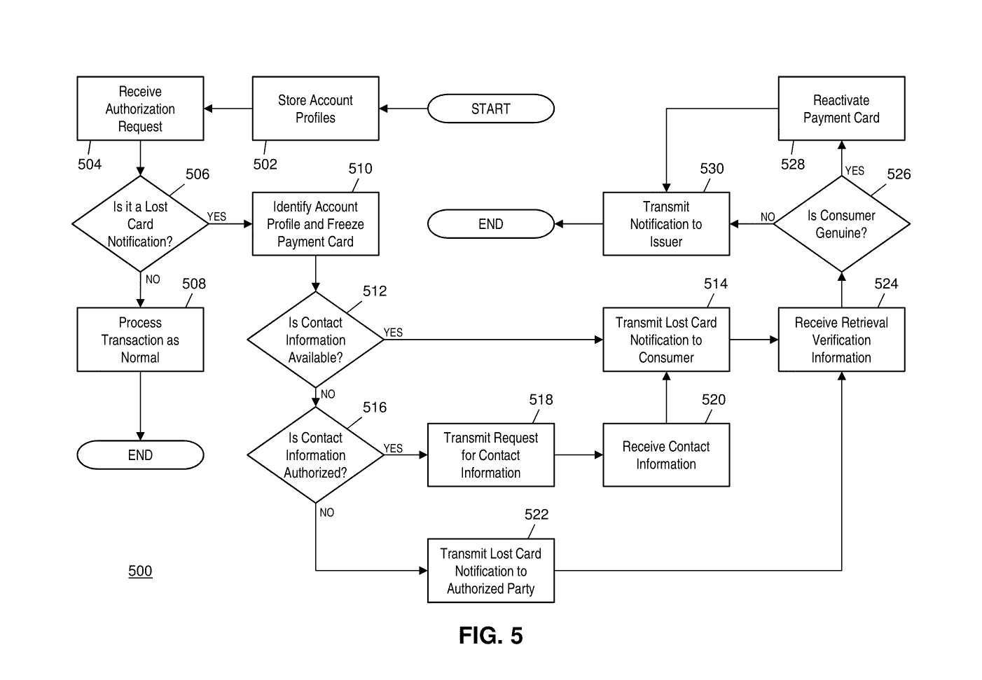

FIG. 5 illustrates a process 500 for the deactivation and then reactivation of a lost and then recovered payment card by the processing server 112.

In step 502, the processing unit 204 of the processing server 112 may generate and store a plurality of account profiles 210 in the account database 208. Each account profile 210 may include an account identifier, authentication data, and an activation flag that indicates an active or inactive status of the related payment card 104. In step 504, the receiving unit 202 of the processing server 112 may receive an authorization request for a payment transaction, which may include at least an account identifier. In step 506, the processing unit 204 may determine if the authorization request is for a lost payment card or is a normal authorization request.

If the authorization request is normal, then, in step 508, the processing unit 204 may process the payment transaction as normal using traditional methods and systems for payment transaction processing that will be apparent to persons having skill in the relevant art. If the authorization request is a lost card notification, such as indicated based on the transaction amount or the data value of another data field included in the authorization request, then, in step 510, the processing unit 204 may identify a specific account profile 210 in the account database 208 that includes the account identifier included in the authorization request and may freeze the associated payment card 104. Freezing the payment card 104 my include updating the activation flag in the specific account profile 210 to indicate the payment card 104 as being inactive, or may include transmitting, by the transmitting unit 206 of the processing server 112, a notification to the issuer 106 that the payment card 104 is lost.

In step 512, the processing server 112 may determine if contact information for the consumer 102 is available, such as by identifying if any contact information is included in the specific account profile 210. If contact information is available, then, in step 514 the transmitting unit 206 may transmit a lost card notification to the consumer 102 that includes merchant information, such as the merchant name and/or geographic location, and, in some embodiments, a verification code (e.g., generated by the processing unit 204) to provide to the merchant 108 for recovery of the payment card 104.

If no contact information for the consumer 102 is available, then, in step 516, the processing unit 204 may determine if the receipt and use of contact information by the processing server 112 is authorized. The determination may be made, for example, based on prior approval provided by the consumer 102 (e.g., for contact by the processing server 112), based on security or privacy concerns, etc. If contact is authorized by the processing server 112, then, in step 518, the transmitting unit 206 may transmit a request for contact information to the issuer 106 or suitable third party (such as a third part that might issue a one-time use e-mail to be used by the transmitter unit 206 to send the communication to the third part, which then links it to the consumer's 102 actual contact information. The message can then be forwarded to the consumer 102 without the transmitting unit 206 learning the personally identifiable information. In step 520, the receiving unit 202 may receive the contact information. Then, the process 500 may proceed to step 514, where the lost card notification is transmitted to the consumer 102 using the contact information.

If the processing server 112 is not authorized to contact the consumer 102 directly, then, in step 522, the lost card notification may be transmitted to the issuer 106 or other authorized party, who may then transmit the notification on to the consumer 102.

Once the consumer 102 has received the lost card notification, the consumer 102 can visit the merchant 108 and recover the payment card 104. As part of the recovery of the payment card 104, a verification message may be submitted to the processing server 112 and received by the receiving unit 202 in step 524. The verification message may be received from the merchant 108, the issuer 106, or consumer 102, and may be an authorization request, login notification, retrieval confirmation, or other suitable message that indicates that the payment card 104 has been recovered by the consumer 102. The verification message may include at least authentication data, which may be data used for authentication or may be the results of an authentication performed by a third party, such as the issuer 106.

In step 526, the processing unit 204 may determine if the consumer 102 is genuine (e.g., is authorized to recover the payment card 104). The determination may be based on the authentication information included in the received verification message and the authentication information included in the specific account profile 210. If the consumer 102 is not genuine, which seems unlikely but could occur if for instance the consumer 102 has lost his mobile device or the communication is otherwise intercepted in a detectable way (e.g., the person showing up for the card is not recognized or a higher level of authentication is required (photo identification for example) which the person cannot produce, etc.), then, in step 530, a notification may be transmitted to the issuer 106 indicating that the payment card 104 has been recovered by an unauthorized party, which may result in cancellation of the payment card 104.

If the consumer 102 is genuine, then, in step 528, the payment card 104 may be reactivated. Reactivation may include updating the activation flag in the specific account profile 210. The process 500 may then proceed to step 530 where a notification is transmitted to the issuer that indicates the successful recovery of the payment card 104 by the consumer 102.

### Exemplary Method for Deactivation and Reactivation of a Lost and Recovered Payment Card

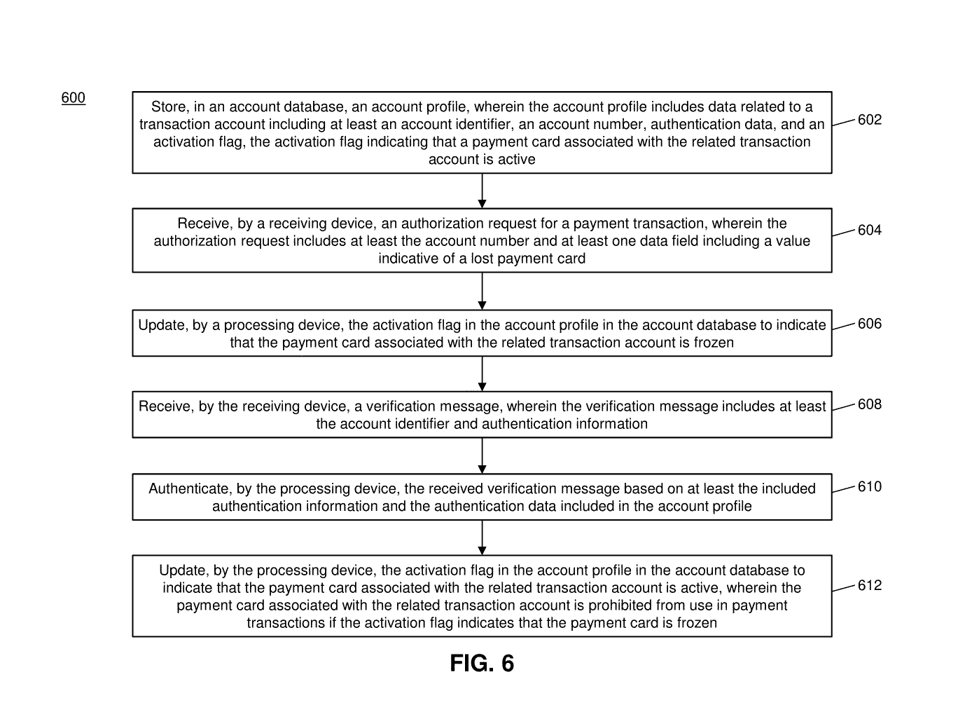

FIG. 6 illustrates a method 600 for the deactivation and reactivation of a lost and recovered payment card using a payment network 110.

In step 602, an account profile (e.g., account profile 210) may be stored in an account database (e.g., the account database 208), wherein the account profile 210 includes data related to a transaction account including at least an account identifier, an account number, authentication data, and an activation flag, the activation flag indicating that a payment card (e.g., the payment card 104) associated with the related transaction account is active. In some embodiments, the authentication data may include biometric data.

In step 604, an authorization request for a payment transaction may be received by a receiving device (e.g., the receiving unit 202), wherein the authorization request includes at least the account number and at least one data field including a value indicative of a lost payment card. In one embodiment, the received authorization request may include a zero transaction amount. In step 606, the activation flag may be updated in the account profile 210 in the account database 208 by a processing device (e.g., the processing unit 204) to indicate that the payment card 104 associated with the related transaction account is frozen.

In step 608, a verification message may be received by the receiving device 202, wherein the verification message includes at least the account identifier and authentication information. In one embodiment, the verification message may be an authorization request for a payment transaction and may further include the account number, and the authentication information may include a personal identification number. In some embodiments, the verification message may be received from an issuer (e.g., the issuer 106) associated with the payment card 104 associated with the related transaction account and the verification message may further include an indication of successful authentication of delivery of the payment card 104 associated with the related transaction account to an authorized user.

In step 610, the received verification message may be authenticated by the processing device 204 based on at least the included authentication information and the authentication data included in the account profile 210. In step 612, the activation flag in the account profile 210 in the account database 208 may be updated by the processing device 204 to indicate that the payment card 104 associated with the related transaction account is active, wherein the payment card 104 associated with the related transaction account is prohibited from use in payment transactions if the activation flag indicates that the payment card 104 is frozen.

In one embodiment, the method 600 may further include: generating, by the processing device 204, a verification value, wherein the generated verification value is a random or pseudo-random number; and transmitting, by a transmitting device (e.g., the transmitting unit 206), the generated verification value to a merchant (e.g., the merchant 108) associated with the received authorization request. In a further embodiment, the authentication data included in the account profile 210 in the account database 208 may include the generated verification value, and the authentication information included in the received verification message may include the generated verification value.

In some embodiments, the account profile 210 may further include contact information. In a further embodiment, the method 600 may also include transmitting, by the transmitting device 206, a notification message based on the contact information. In an even further embodiment, the notification message may be transmitted to at least one of: an authorized user associated with the payment card 104 associated with the related transaction account and a third party. In another even further embodiment, the notification message may include at least merchant data corresponding to a merchant 108 associated with the received authorization request.

In one embodiment, the method 600 may further include: receiving, by the receiving device, contact information associated with the related transaction account; and transmitting, by a transmitting device 206, a notification message to an authorized user associated with the payment card 104 associated with the related transaction account. In a further embodiment, the method 600 may even further include generating, by the processing device 204, a verification value, wherein the generated verification value is a random or pseudo-random number, and wherein the notification message includes at least the generated verification value. In an even further embodiment, the method 600 may also include transmitting, by the transmitting device 206, the generated verification value to a merchant 108 associated with the received authorization request.

### Computer System Architecture

FIG. 7 illustrates a computer system 700 in which embodiments of the present disclosure, or portions thereof, may be implemented as computer-readable code. For example, the processing server 112 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for recovering lost payment cards. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for deactivation and reactivation of a lost and recovered payment card, comprising:
storing, in an account database, an account profile, wherein the account profile includes data related to a transaction account including at least an account identifier, an account number, authentication data, and an activation flag, the activation flag indicating that a payment card associated with the related transaction account is active;
receiving, by a receiving device, an authorization request for a payment transaction, wherein the authorization request includes at least the account number and at least one data field including a value indicative of a lost payment card;
updating, by a processing device, the activation flag in the account profile in the account database to indicate that the payment card associated with the related transaction account is frozen;
receiving, by the receiving device, a verification message, wherein the verification message includes at least the account identifier and authentication information;
authenticating, by the processing device, the received verification message based on at least the included authentication information and the authentication data included in the account profile; and
updating, by the processing device, the activation flag in the account profile in the account database to indicate that the payment card associated with the related transaction account is active, wherein
the payment card associated with the related transaction account is prohibited from use in payment transactions if the activation flag indicates that the payment card is frozen.

2. The method of claim 1, further comprising:
generating, by the processing device, a verification value, wherein the generated verification value is a random or pseudo-random number; and
transmitting, by a transmitting device, the generated verification value to a merchant associated with the received authorization request.

3. The method of claim 2, wherein
the authentication data included in the account profile in the account database includes the generated verification value, and
the authentication information included in the received verification message includes the generated verification value.

4. The method of claim 1, wherein
the verification message is an authorization request for a payment transaction,
the verification message further includes the account number, and
the authentication information includes a personal identification number.

5. The method of claim 1, wherein the authentication data includes biometric data.

6. The method of claim 1, wherein
the verification message is received from an issuer associated with the payment card associated with the related transaction account, and
the verification message further includes an indication of successful authentication of delivery of the payment card associated with the related transaction account to an authorized user.

7. The method of claim 1, wherein the account profile further includes contact information.

8. The method of claim 7, further comprising:
transmitting, by a transmitting device, a notification message based on the contact information.

9. The method of claim 8, wherein the notification message is transmitted to at least one of: an authorized user associated with the payment card associated with the related transaction account and a third party.

10. The method of claim 8, wherein the notification message includes at least merchant data corresponding to a merchant associated with the received authorization request.

11. The method of claim 1, further comprising:
receiving, by the receiving device, contact information associated with the related transaction account; and
transmitting, by a transmitting device a notification message to an authorized user associated with the payment card associated with the related transaction account.

12. The method of claim 11, further comprising:
generating, by the processing device, a verification value, wherein the generated verification value is a random or pseudo-random number, wherein
the notification message includes at least the generated verification value.

13. The method of claim 12, further comprising:
transmitting, by a transmitting device, the generated verification value to a merchant associated with the received authorization request.

14. The method of claim 1, wherein the received authorization request includes a zero transaction amount.

15. A system for deactivation and reactivation of a lost and recovered payment card, comprising:
an account database configured to store an account profile, wherein the account profile includes data related to a transaction account including at least an account identifier, an account number, authentication data, and an activation flag, the activation flag indicating that a payment card associated with the related transaction account is active;
a receiving device configured to receive an authorization request for a payment transaction, wherein the authorization request includes at least the account number and at least one data field including a value indicative of a lost payment card; and
a processing device configured to update the activation flag in the account profile in the account database to indicate that the payment card associated with the related transaction account is frozen, wherein
the receiving device is further configured to receive a verification message, wherein the verification message includes at least the account identifier and authentication information,
the processing device is further configured to
authenticate the received verification message based on at least the included authentication information and the authentication data included in the account profile, and
update the activation flag in the account profile in the account database to indicate that the payment card associated with the related transaction account is active, and
the payment card associated with the related transaction account is prohibited from use in payment transactions if the activation flag indicates that the payment card is frozen.

16. The system of claim 15, further comprising:
a transmitting device, wherein
the processing device is further configured to generate a verification value, wherein the generated verification value is a random or pseudo-random number, and
the transmitting device is configured to transmit the generated verification value to a merchant associated with the received authorization request.

17. The system of claim 16, wherein
the authentication data included in the account profile in the account database includes the generated verification value, and
the authentication information included in the received verification message includes the generated verification value.

18. The system of claim 15, wherein
the verification message is an authorization request for a payment transaction,
the verification message further includes the account number, and
the authentication information includes a personal identification number.

19. The system of claim 15, wherein the authentication data includes biometric data.

20. The system of claim 15, wherein
the verification message is received from an issuer associated with the payment card associated with the related transaction account, and
the verification message further includes an indication of successful authentication of delivery of the payment card associated with the related transaction account to an authorized user.

21. The system of claim 15, wherein the account profile further includes contact information.

22. The system of claim 21, further comprising:
a transmitting device configured to transmit a notification message based on the contact information.

23. The system of claim 22, wherein the notification message is transmitted to at least one of: an authorized user associated with the payment card associated with the related transaction account and a third party.

24. The system of claim 22, wherein the notification message includes at least merchant data corresponding to a merchant associated with the received authorization request.

25. The system of claim 15, further comprising:
a transmitting device, wherein
the receiving device is further configured to receive contact information associated with the related transaction account, and
the transmitting device is configured to transmit a notification message to an authorized user associated with the payment card associated with the related transaction account.

26. The system of claim 25, wherein
the processing device is further configured to generate a verification value, wherein the generated verification value is a random or pseudo-random number, and
the notification message includes at least the generated verification value.

27. The system of claim 26, further comprising:
a transmitting device configured to transmit the generated verification value to a merchant associated with the received authorization request.

28. The system of claim 15, wherein the received authorization request includes a zero transaction amount.
